(19) United States
(12) Patent Application Publication
(10) Pub. No.: US 2023/0054685 A1
(43) Pub. Date: Feb. 23, 2023

(54) STACKED ELECTRODE ARCHITECTURES FOR ELECTROCHEMICAL DEVICES AND METHODS FOR MAKING ELECTROCHEMICAL DEVICES

(71) Applicant: GM GLOBAL TECHNOLOGY OPERATIONS LLC, Detroit, MI (US)

(72) Inventors: Michael A. Lelli, Rochester, MI (US); Jing Gao, Rochester, MI (US)

(73) Assignee: GM GLOBAL TECHNOLOGY OPERATIONS LLC, Detroit, MI (US)

(21) Appl. No.: 17/407,487

(22) Filed: Aug. 20, 2021

(51) Int. Cl. H01M 10/0583; H01M 50/538; H01M 50/533

(52) U.S. Cl. CPC H01M 10/0583; H01M 50/538; H01M 50/533; H01M 2220/20

(57) ABSTRACT

Presented are stacked electrode designs for electrochemical devices, methods for making/using such electrochemical devices, and lithium-class cylindrical and prismatic battery cells with stacked electrode architectures. An electrochemical device employs multiple first (e.g., anode) electrodes and multiple second (e.g., cathode) electrodes, each of which includes an active (anode/cathode) electrode material borne by an electrode body and a flexible tab projecting from the electrode body. Multiple electrically insulating separators are interleaved between and stacked along a central stack axis with the electrodes to define an electrode stack. A first electrically conductive current collector fully or partially surrounds the electrode stack and interference fits with the electrode tabs of the first electrodes to electrically connect thereto. A second electrically conductive current collector is disposed inside the first current collector, aligned substantially parallel with the central stack axis, and interference fit with the electrode tabs of the second electrodes to electrically connect thereto.

### INTRODUCTION

The present disclosure relates generally to electrochemical devices. More specifically, aspects of this disclosure relate to stacked electrode designs for cylindrical and prismatic lithium-class battery cells.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid electric and full electric (collectively “electric-drive”) vehicles, on the other hand, utilize alternative power sources to propel the vehicle and, thus, minimize or eliminate reliance on a fossil-fuel based engine for tractive power.

A full-electric vehicle (FEV)—colloquially labeled an “electric car”—is a type of electric-drive vehicle configuration that altogether omits the internal combustion engine and attendant peripheral components from the powertrain system, relying on a rechargeable energy storage system (RESS) and a traction motor for vehicle propulsion. The engine assembly, fuel supply system, and exhaust system of an ICE-based vehicle are replaced with a single or multiple traction motors, a traction battery pack, and battery cooling and charging hardware in a battery-based FEV. Hybrid electric vehicle (HEV) powertrains, in contrast, employ multiple sources of tractive power to propel the vehicle, most commonly operating an internal combustion engine assembly in conjunction with a battery-powered or fuel-cell-powered traction motor. Since hybrid-type, electric-drive vehicles are able to derive their power from sources other than the engine, HEV engines may be turned off, in whole or in part, while the vehicle is propelled by the electric motor(s).

Many commercially available hybrid electric and full electric vehicles employ a rechargeable traction battery pack to store and supply the requisite power for operating the powertrain's traction motor unit(s). In order to generate tractive power with sufficient vehicle range and speed, a traction battery pack is significantly larger, more powerful, and higher in capacity (Amp-hr) than a standard 12-volt starting, lighting, and ignition (SLI) battery. Contemporary traction battery packs, for example, group stacks of battery cells (e.g., 8-16 cells/stack) into individual battery modules (e.g., 10-40 modules/pack) that are mounted onto the vehicle chassis by a battery pack housing or support tray. Stacked electrochemical battery cells may be connected in series or parallel through use of an electrical interconnect board (ICB) or front-end DC bus bar assembly. A dedicated Electronic Battery Control Module (EBCM), through collaborative operation with a Powertrain Control Module (PCM) and Traction Power Inverter Module (TPIM), regulates the opening and closing of battery pack contactors to govern operation of the battery pack.

There are four primary types of batteries that are used in electric-drive vehicles: lithium-class batteries, nickel-metal hydride batteries, ultracapacitor batteries, and lead-acid batteries. As per lithium-class designs, lithium-metal (primary) batteries and lithium-ion (secondary) batteries make up the bulk of commercial lithium battery (LiB) configurations with Li-ion batteries being employed in automotive applications due to their enhanced stability, energy density, and rechargeable capabilities. A standard lithium-ion cell is generally composed to at least two conductive electrodes, an electrolyte material, and a permeable separator, all of which are enclosed inside an electrically insulated packaging. One electrode serves as a positive (“cathode”) electrode and the other electrode serves as a negative (“anode”) electrode during cell discharge. Rechargeable Li-ion batteries operate by reversibly passing lithium ions back and forth between these negative and positive electrodes. The separator—oftentimes a microporous polymeric membrane—is disposed between the two electrodes to prevent electrical short circuits while also allowing the transport of ionic charge carriers. The electrolyte is suitable for conducting lithium (Li) ions and may be in solid form (e.g., solid state diffusion), liquid form (e.g., liquid phase diffusion), or quasi-solid form (e.g., solid electrolyte entrained within a liquid carrier). Lithium-ions move from the negative electrode to the positive electrode during discharge of the battery while under load, and in the opposite direction when recharging the battery.

### SUMMARY

Presented herein are stacked electrode designs for electrochemical devices, methods for manufacturing and methods for operating such electrochemical devices, and lithium-class cylindrical and prismatic battery cells with stacked electrode architectures. By way of example, a lithium-metal cylindrical can cell employs a stack of annular anode electrodes interleaved with annular cathode electrodes. Insulation pads may be seated on opposing longitudinal ends of the stack, and the insulated stack packaged inside a protective outer housing (i.e., “cell casing”). The stacked electrodes are nested inside of a current collector cylinder such that the anode electrodes, cathode electrodes, and current collector cylinder are mutually coaxial with and circumscribe a current collector bar. An electrically insulating and ionically conductive separator (e.g., polymeric separator immersed within liquid electrolyte or including a solid electrolyte) may be disposed between each pair of neighboring electrodes.

One set of electrodes (e.g., the cathode electrodes) press-fits onto and thereby electrically connects with the current collector bar via inner-diameter (ID) tabs projecting radially inward from a central hole of the electrodes. Outer-diameter (OD) peripheries of these electrodes may be covered with an electrical insulator or the diameter of these electrodes may be reduced to space the OD edges from the interior of the current collector cylinder. Conversely, the other set of electrodes (e.g., the anode electrodes) press-fits into and thereby electrically connects with the current collector cylinder via OD tabs projecting radially outward from the electrodes. ID edges of these electrodes may be covered with an electrical insulator or the diameter of central hole of these electrodes may be increased to space the ID edges from the exterior of the current collector bar. Moreover, a biasing member, such as a helical compression spring, may be compressed between the stacked electrodes and a housing cap or housing base to maintain the electrodes in compression with one another while inside the housing.

Attendant benefits for at least some of the disclosed concepts include a stacked electrode architecture that enables cylindrical and prismatic battery cells to facially compress the stack of interleaved electrodes, e.g., for lithium-metal anode applications. In addition, laying the electrodes flat against one another in a stack enables prismatic battery cells to increase the number of electrode layers, e.g., as compared to conventional “jelly roll” configurations. Other attendant benefits may include increased heat dissipation characteristics and a reduced electrode geometry that helps to ensure uniform current density, electrode morphology, and mechanical properties. In addition to improved thermal performance and uniform operating parameters, disclosed concepts may help to increase driving range, fuel economy, and pack performance for electric-drive vehicles. Disclosed features also enable an “anodeless” design which incorporates or consists essentially of multiple collectors whereby lithium is supplied by a cathode or cathodes that plate(s) on and strips from an anode collector as a means of ionic transfer.

Aspects of this disclosure are directed to electrochemical devices, such as cylindrical and prismatic battery cells used in the battery modules of vehicular traction battery packs. In an example, an electrochemical device includes two sets of electrodes: multiple first (anode) electrodes, each of which has one or more layers of active (anode) electrode material borne by a respective electrode body; and multiple second (cathode) electrodes, each of which has one or more layers of active (cathode) electrode material, distinct from the first electrodes' active material, borne by a respective electrode body. One or more flexible electrode tabs projects from the body of each electrode. Electrically insulating separators are interleaved between and stacked along a central stack axis with the electrodes to define an electrode stack. A first (negative) current collector fully or partially surrounds the electrode stack. The set of first electrodes electrically connects to the first current collector by interference fitting (i.e., press fitting) the electrode tabs of the first electrodes to a mating surface of the first current collector. Additionally, a second current collector is located inside the first current collector and aligned substantially parallel with the central stack axis. The set of second electrodes electrically connects to the second current collector by interference/press fitting the electrode tabs of the second electrodes to a mating surface of the second current collector.

Additional aspects of this disclosure are directed to lithium-class battery cells with weld-free stacked electrode architectures, rechargeable battery packs employing such lithium-class battery cells, and motor vehicles equipped with such battery packs. As used herein, the terms “vehicle” and “motor vehicle” may be used interchangeably and synonymously to include any relevant vehicle platform, such as passenger vehicles (ICE, REV, FEV, fuel cell, fully and partially autonomous, etc.), commercial vehicles, industrial vehicles, tracked vehicles, off-road and all-terrain vehicles (ATV), motorcycles, farm equipment, watercraft, aircraft, e-bikes, e-scooters, etc. For non-automotive applications, disclosed concepts may be implemented for any logically relevant use, including stand-alone power stations and portable power packs, photovoltaic systems, handheld electronic devices, pumping equipment, machine tools, appliances, etc. While not per se limited, disclosed concepts may be particularly advantageous for use in lithium-metal cylindrical and prismatic can cells.

In an example, a motor vehicle includes a vehicle body with a passenger compartment, multiple road wheels rotatably mounted to the vehicle body (e.g., via wheel corner modules coupled to a unibody chassis or a body-on-frame chassis), and other standard original equipment. For electric-drive vehicle applications, one or more electric traction motors operate alone (e.g., for FEV powertrains) or in conjunction with an internal combustion engine assembly (e.g., for HEV powertrains) to selectively drive one or more of the road wheels to propel the vehicle. A rechargeable traction battery pack is mounted onto the vehicle body and operable to power the traction motor(s).

Continuing with the discussion of the preceding example, the traction battery pack contains multiple lithium-class battery cells. Each battery cell is fabricated with a plurality of first electrodes, each of which has a first active electrode material borne by a substantially flat first body, and a plurality of second electrodes, each of which has a second active electrode material, distinct from the first active electrode material, borne by a substantially flat second body. Multiple flexible electrode tabs project from the body of each first electrode, and multiple flexible electrode tabs project from the body of each second electrode. A set of substantially flat and electrically insulating separators is interleaved between and stacked along a central stack axis with the electrodes to form an electrode stack. A first electrically conductive current collector, which at least partially surrounds the electrode stack, is interference fit with the flexible electrode tabs of the first electrodes. In addition, a second current collector is disposed inside the first current collector and aligned substantially parallel with the central stack axis. The second current collector interference fits with the second electrode tabs of the second electrodes.

Aspects of this disclosure are directed to manufacturing processes, control logic, and computer-readable media (CRM) for making and/or using any of the disclosed electrochemical devices, battery packs, and/or vehicles. In an example, a method is presented for assembling an electrochemical device. This representative method includes, in any order and in any combination with any of the above and below disclosed options and features: receiving a plurality of first electrodes each having a first active electrode material borne by a first body and a flexible first electrode tab projecting from the first body; receiving a plurality of second electrodes each having a second active electrode material, distinct from the first active electrode material, borne by a second body and a flexible second electrode tab projecting from the second body; receiving a plurality of electrically insulating separators; interleaving each of the separators between one of the first electrodes and one of the second electrodes; stacking the first and second electrodes with the interleaved separators along a central stack axis to define an electrode stack; positioning a first current collector at least partially around the electrode stack such that the first electrode tabs interference fit with the first current collector to thereby electrically connect the first electrodes to the first current collector; and positioning a second current collector inside the first current collector and aligned substantially parallel with the central stack axis such that the second electrode tabs interference fit with the second current collector to thereby electrically connect the second electrodes to the second current collector. The above and below-described method steps may be performed manually (e.g., by an operator), may be automated (e.g., by a robotic cell), or a combination of both.

For any of the disclosed devices, vehicles, and methods, the electrode bodies of the first and second electrodes may each have a substantially flat annular shape. As a further option, the electrode bodies have respective central holes that are coaxially aligned on the central stack axis to define a stack cavity, which extends through of the center of the electrode stack. In this instance, the second current collector includes an elongated, electrically conductive bar that extends axially through the central stack cavity. Each tab of each second electrode may include multiple electrode tabs that project radially inward from an inner-diameter edge of its electrode body, circumferentially spaced around the electrode body, and bent against an outer surface of the electrically conductive bar. The electrode body of each second electrode may have an outer-diameter edge with a layer of electrical insulation, e.g., to prevent electrical contact with the first current collector.

For any of the disclosed devices, vehicles, and methods, the first current collector may include an electrically conductive cylinder that is concentric with and surrounds the electrode stack. In this instance, each electrode tab of each first electrode may include multiple electrode tabs that projecting radially outward from an outer-diameter periphery of its electrode body, circumferentially spaced around the electrode body, and bent against an inner surface of the electrically conductive cylinder. The electrode body of each first electrode may have an inner-diameter edge with a layer of electrical insulation, e.g., to prevent electrical contact with the second current collector. The separators may be ring-shaped, porous polymeric sheets.

For any of the disclosed devices, vehicles, and methods, the electrochemical device may also include a rigid outer housing that securely contains therein the electrode stack and the two current collectors. The outer housing may be a two-piece construction with a main housing and a housing cap that closes off an open end of the main housing. An optional biasing member may be compressed between the electrode stack and either the housing cap or the main housing. The biasing member may be sandwiched between a pair of non-conductive plates or metallic plates each coated with a layer of insulation. The housing cap may be fabricated with one or more passive or active gas vents.

For any of the disclosed devices, vehicles, and methods, the electrode bodies of the first electrodes may each have a substantially flat first polygonal shape with a first size (e.g., a rectangle with an enlarged plan-view area), and the electrode bodies of the second electrodes may each have a substantially flat second polygonal shape with a second size that is distinct from the first size (e.g., a rectangle with a reduced plan-view area). In this example, the second current collector may include an electrically conductive plate that extends longitudinally along a lateral side of the electrode stack, abutting the second electrodes, and spaced relation to the first electrodes. In addition, the first current collector includes an electrically conductive cylinder coaxial with and surrounding the first and second electrodes. It is also envisioned that the first current collector may include another electrically conductive plate that extends longitudinally along another lateral side of the electrode stack, opposite that of the second current collector's electrically conductive plate. In this instance, the first current collector's electrically conductive plate abuts the first electrodes and is spaced from the second electrodes.

The above summary does not represent every embodiment or every aspect of this disclosure. Rather, the above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes any and all combinations and subcombinations of the elements and features described above and below.

### BRIEF DESCRIPTION OF THE DRAWINGS

FIG. 1 is a schematic illustration of a representative electric-drive vehicle with a hybrid electric powertrain employing an electric motor/generator unit (MGU) powered by a rechargeable traction battery pack in accord with aspects of the present disclosure.

FIG. 2 is a schematic illustration of a representative lithium-class electrochemical device that operates in accordance with aspects of the present disclosure.

FIGS. 3A-3C are side-sectional view and two plan-sectional view illustrations, respectively, of a representative cylindrical battery cell with a stacked electrode architecture in accord with aspects of the disclosed concepts.

FIG. 4 is a workflow diagram illustrating a representative manufacturing system and method for assembling a cylindrical battery cell with stacked electrode design, in which some or all of the illustrated operations may correspond to memory-stored, controller-executable instructions in accord with aspects of the disclosed concepts.

FIGS. 5A and 5B are plan-view and side-sectional view illustrations, respectively, of a representative prismatic battery cell with a stacked electrode architecture in accord with aspects of the disclosed concepts.

FIGS. 6A and 6B are plan-view and side-sectional view illustrations, respectively, of another representative prismatic battery cell with a stacked electrode architecture in accord with aspects of the disclosed concepts.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed, for instance, by the appended claims.

### DETAILED DESCRIPTION

This disclosure is susceptible of embodiment in many different forms. Representative examples of the disclosure are shown in the drawings and herein described in detail with the understanding that these embodiments are provided as an exemplification of the disclosed principles, not limitations of the broad aspects of the disclosure. To that end, elements and limitations that are described, for example, in the Abstract, Introduction, Summary, Description of the Drawings, and Detailed Description sections, but not explicitly set forth in the claims, should not be incorporated into the claims, singly or collectively, by implication, inference, or otherwise. Moreover, the drawings discussed herein may not be to scale and are provided purely for instructional purposes. Thus, the specific and relative dimensions shown in the Figures are not to be construed as limiting.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and permutations thereof, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle, when the vehicle is operatively oriented on a horizontal driving surface.

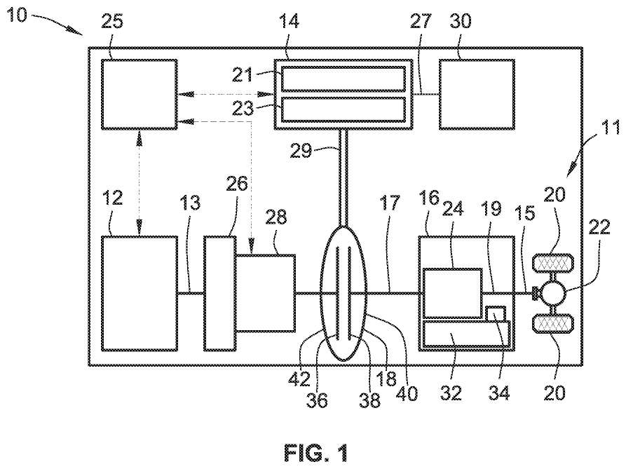

Referring now to the drawings, wherein like reference numbers refer to like features throughout the several views, there is shown in FIG. 1 a schematic illustration of a representative automobile, which is designated generally at 10 and portrayed herein for purposes of discussion as a passenger vehicle with a parallel two-clutch (P2) hybrid-electric powertrain. The illustrated automobile 10—also referred to herein as “motor vehicle” or “vehicle” for short—is merely an exemplary application with which novel aspects of this disclosure may be practiced. In the same vein, implementation of the present concepts into a hybrid electric powertrain should also be appreciated as a representative implementation of the novel concepts disclosed herein. As such, it will be understood that facets of this disclosure may be applied to other powertrain architectures, incorporated into any logically relevant type of motor vehicle, and utilized for both automotive and non-automotive applications alike. Lastly, only select components have been shown and will be described in additional detail herein. Nevertheless, the vehicles and electrochemical devices discussed below may include numerous additional and alternative features, and other available peripheral components and hardware, for carrying out the various methods and functions of this disclosure.

The representative vehicle powertrain system is shown in FIG. 1 with a prime mover—represented herein by a restartable internal combustion engine (ICE) assembly 12 and an electric motor/generator unit (MGU) 14—that drivingly connects to a driveshaft 15 of a final drive system 11 by a multi-speed automatic power transmission 16. The engine 12 transfers power, typically by way of torque via an engine crankshaft 13, to an input side of the transmission 16. Engine torque is first transmitted via the crankshaft 13 to rotate an engine-driven torsional damper assembly 26, and concomitantly transferred through the torsional damper assembly 26 to an engine disconnect device 28. This engine disconnect device 28, when operatively engaged, transmits torque received from the ICE assembly 12, by way of the damper 26, to input structure of the torque converter (TC) assembly 18. As the name implies, the engine disconnect device 28 may be selectively disengaged to drivingly disconnect the ICE 12 from the motor 14, TC assembly 18, and transmission 16.

To propel the hybrid vehicle 10 of FIG. 1, the transmission 16 is adapted to receive, selectively manipulate, and distribute tractive power output from the engine 12 and motor 14 to the vehicle's final drive system 11. The final drive system 11 is represented herein by a driveshaft 15, rear differential 22, and a pair of rear road wheels 20. The power transmission 16 and torque converter 18 of FIG. 1 may share a common transmission oil pan or “sump” 32 for supply of hydraulic fluid. A shared transmission pump 34 provides sufficient hydraulic pressure for the fluid to selectively actuate hydraulically activated elements of the transmission 16, the TC assembly 18 and, for some implementations, the engine disconnect device 28.

The ICE assembly 12 operates to propel the vehicle 10 independently of the electric traction motor 14, e.g., in an “engine-only” operating mode, or in cooperation with the motor 14, e.g., in “vehicle-launch” or “motor-boost” operating modes. In the example depicted in FIG. 1, the ICE assembly 12 may be any available or hereafter developed engine, such as a compression-ignited diesel engine or a spark-ignited gasoline or flex-fuel engine, which is readily adapted to provide its available power output typically at a number of revolutions per minute (RPM). Although not explicitly portrayed in FIG. 1, it should be appreciated that the final drive system 11 may take on any available configuration, including front wheel drive (FWD) layouts, rear wheel drive (RWD) layouts, four-wheel drive (4WD) layouts, all-wheel drive (AWD) layouts, six-by-four (6×4) layouts, etc.

FIG. 1 also depicts an electric motor/generator unit (“motor”) 14 that operatively connects via a motor support hub, shaft, or belt 29 to the hydrodynamic torque converter 18. The torque converter 18, in turn, drivingly connects the motor 14 to an input shaft 17 of the transmission 16. The electric motor/generator unit 14 is composed of an annular stator assembly 21 circumscribing and concentric with a cylindrical rotor assembly 23. Electric power is provided to the stator 21 through a high-voltage electrical system, including electrical conductors/cables 27 that pass through the motor housing via suitable sealing and insulating feedthroughs (not illustrated). Conversely, electric power may be provided from the MGU 14 to an onboard traction battery pack 30, e.g., through regenerative braking. Operation of any of the illustrated powertrain components may be governed by an onboard or remote vehicle controller or network of controllers and devices, which is represented in FIG. 1 by a programmable electronic control unit (ECU) 25.

Power transmission 16 may use differential gearing 24 to achieve selectively variable torque and speed ratios between transmission input and output shafts 17 and 19, respectively. One form of differential gearing is the epicyclic planetary gear arrangement, which offers the advantage of compactness and different torque and speed ratios among members of the planetary gearing. Traditionally, hydraulically actuated torque establishing devices, such as clutches and brakes, are selectively engageable to activate the aforementioned gear elements for establishing desired forward and reverse speed ratios between the transmission's input and output shafts 17, 19. While envisioned as a 6-speed or 8-speed automatic transmission, the power transmission 16 may optionally take on other functionally appropriate configurations, including Continuously Variable Transmission (CVT) architectures, automated-manual transmissions, etc.

Hydrodynamic torque converter assembly 18 of FIG. 1 operates as a fluid coupling for operatively connecting the engine 12 and motor 14 with the internal epicyclic gearing 24 of the power transmission 16. Disposed within an internal fluid chamber of the torque converter assembly 18 is a bladed impeller 36 juxtaposed with a bladed turbine 38. The impeller 36 is juxtaposed in serial power-flow fluid communication with the turbine 38, with a stator (not shown) interposed between the impeller 36 and turbine 38 to selectively alter fluid flow therebetween. The transfer of torque from the engine and motor output members 13, 29 to the transmission 16 via the TC assembly 18 is through stirring excitation of hydraulic fluid, such as transmission oil, inside the TC's internal fluid chamber caused by rotation of the impeller and turbine 36, 38 blades. To protect these components, the torque converter assembly 18 is constructed with a TC pump housing, defined principally by a transmission-side pump shell 40 fixedly attached to an engine-side pump cover 42 such that a working hydraulic fluid chamber is formed therebetween.

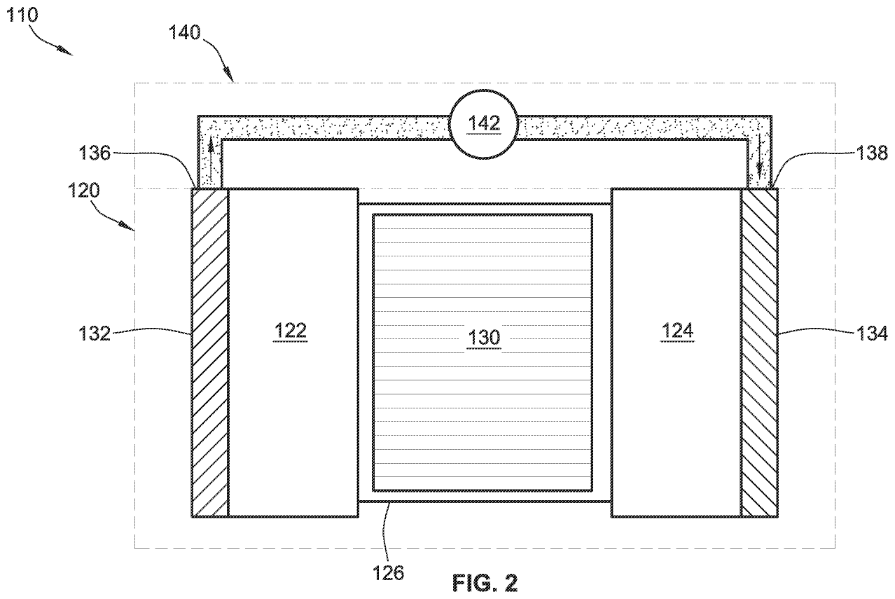

Presented in FIG. 2 is an exemplary electrochemical device in the form of a rechargeable lithium-class battery 110 that may offer direct current fast charging (DCFC) and power a desired electrical load, such as automobile 10 of FIG. 1. Battery 110 includes a pair of electrically conductive electrodes, namely a first (negative or anode) working electrode 122 and a second (positive or cathode) working electrode 124, packaged inside a protective outer housing 120. In at least some configurations, the battery housing 120 may be an envelope-like pouch that is formed of aluminum foil or other suitable sheet material. Both sides of a metallic pouch may be coated with a polymeric finish to insulate the metal from the internal cell elements and from adjacent cells, if any. Alternatively, the battery housing (or “cell casing”) 120 may take on a cylindrical metal can configuration, i.e., for cylindrical battery cell configurations, or a polyhedral metal box configuration, i.e., for prismatic battery cell configurations. Reference to either working electrode 122, 124 as an “anode” or “cathode” or, for that matter, as “positive” or “negative” does not limit the electrodes 122, 124 to a particular polarity as the system polarity may change depending on whether the battery 110 is being operated in a charge mode or a discharge mode. Although FIG. 2 illustrates a single battery cell unit inserted within the battery housing 120, it should be appreciated that the housing 120 may stow therein a stack of multiple cell units (e.g., five to five thousand cells or more).

With continuing reference to FIG. 2, anode electrode 122 may be fabricated with an active anode electrode material that is capable of incorporating lithium ions during a battery charging operation and releasing lithium ions during a battery discharging operation. In at least some implementations, the anode electrode 122 is manufactured, in whole or in part, from a lithium metal, such as lithium-aluminum (LiAl) alloy materials with an Li/Al atomic ratio in a range from 0 at. %Li/Al<70 at. %, and/or aluminum alloys with Al atomic ratio>50 at. % (e.g., lithium metal is smelt). Additional examples of suitable active anode electrode materials include carbonaceous materials (e.g., graphite, hard carbon, soft carbon etc.), silicon, silicon-carbon blended materials (silicon-graphite composite), Li4Ti5O12, transition-metals (alloy types, e.g., Sn), metal oxide/sulfides (e.g., SnO2, FeS and the like), etc. In this regard, the cathode electrode 124 may be fabricated with an active cathode electrode material that is capable of supplying lithium ions during a battery charging operation and incorporating lithium ions during a battery discharging operation. The cathode 124 material may include, for instance, lithium transition metal oxide, phosphate, or silicate, such as LiMO2 (M=Co, Ni, Mn, or combinations thereof); LiM2O4 (M=Mn, Ti, or combinations thereof), LiMPO4 (M=Fe, Mn, Co, or combinations thereof), and LiMxM′2-xO4 (M, M′=Mn or Ni). Additional examples of suitable active cathode electrode materials include lithium nickel cobalt manganese oxide (NCM), lithium nickel cobalt aluminum oxide (NCA), lithium nickel cobalt manganese aluminum oxide (NCMA), and other lithium transition-metal oxides.

Disposed inside the battery housing 120 between the two electrodes 122, 124 is a porous separator 126, which may be in the nature of a microporous or nanoporous polymeric separator. The porous separator 126 may include a non-aqueous fluid electrolyte composition and/or solid electrolyte composition, collectively designated 130, which may also be present in the negative electrode 122 and the positive electrode 124. A negative electrode current collector 132 may be positioned on or near the negative electrode 122, and a positive electrode current collector 134 may be positioned on or near the positive electrode 124. The negative electrode current collector 132 and positive electrode current collector 134 respectively collect and move free electrons to and from an external circuit 140. An interruptible external circuit 140 with a load 142 connects to the negative electrode 122, through its respective current collector 132 and electrode tab 136, and to the positive electrode 124, through its respective current collector 134 and electrode tab 138. Separator 126 may be a sheet-like structure that is composed of a porous polyolefin membrane, e.g., with a porosity of about 35% to 65% and a thickness of approximately 25-30 microns. Electrically non-conductive ceramic particles (e.g., silica) may be coated onto the porous membrane surfaces of the separators 126.

The porous separator 126 may operate as both an electrical insulator and a mechanical support structure by being sandwiched between the two electrodes 122, 124 to prevent the electrodes from physically contacting each other and, thus, the occurrence of a short circuit. In addition to providing a physical barrier between the electrodes 122, 124, the porous separator 126 may provide a minimal resistance path for internal passage of lithium ions (and related anions) during cycling of the lithium ions to facilitate functioning of the battery 110. For some optional configurations, the porous separator 126 may be a microporous polymeric separator including a polyolefin. The polyolefin may be a homopolymer, which is derived from a single monomer constituent, or a heteropolymer, which is derived from more than one monomer constituent, and may be either linear or branched. In a solid-state battery, the role of the separator may be partially/fully provided by a solid electrolyte layer.

Operating as a rechargeable energy storage system (RESS), battery 110 generates electric current that is transmitted to one or more loads 142 operatively connected to the external circuit 140. While the load 142 may be any number of electrically powered devices, a few non-limiting examples of power-consuming load devices include an electric motor for a hybrid electric vehicle or an all-electric vehicle, a laptop computer or tablet computer, a cellular smartphone, cordless power tools and appliances, portable power stations, etc. The battery 110 may include a variety of other components that, while not depicted herein for simplicity and brevity, are nonetheless readily available. For instance, the battery 110 may include one or more gaskets, terminal caps, tabs, battery terminals, and other commercially available components or materials that may be situated on or in the battery 110. Moreover, the size and shape and operating characteristics of the battery 110 may vary depending on the particular application for which it is designed.

Discussed below are stacked electrode architectures for improved thermal performance and uniform operating characteristics of electrochemical devices, such as cylindrical and prismatic battery cell formats. By way of non-limiting example, a cylindrical battery cell may employ a stack of ring-shaped or partial ring-shape electrodes that is interleaved with ring-shaped or partial ring-shaped separators. Inner-diameter edges of the cathode electrodes connect to a positive current collector packaged at the center of the cell stack, whereas outer-diameter edges of the anode electrodes connect to a negative current collector that envelops the electrode stack or is interposed between the stack and a cell casing. Alternatively, the anode electrodes may connect to a negative current collector at the center of the cell stack, whereas the cathode electrodes may connect to a positive current collector that is adjacent to or surrounds the electrode stack.

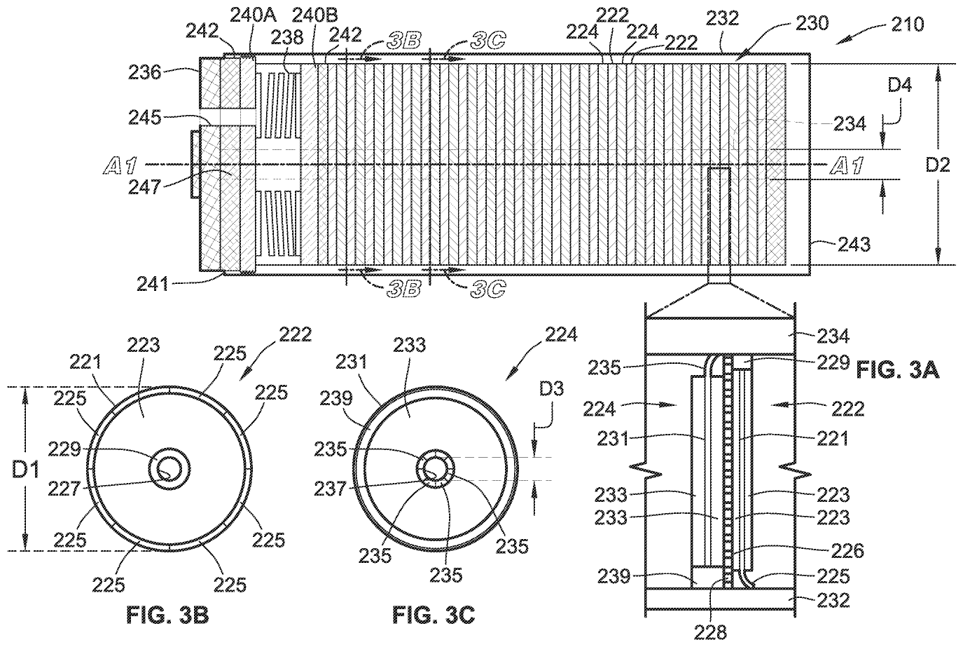

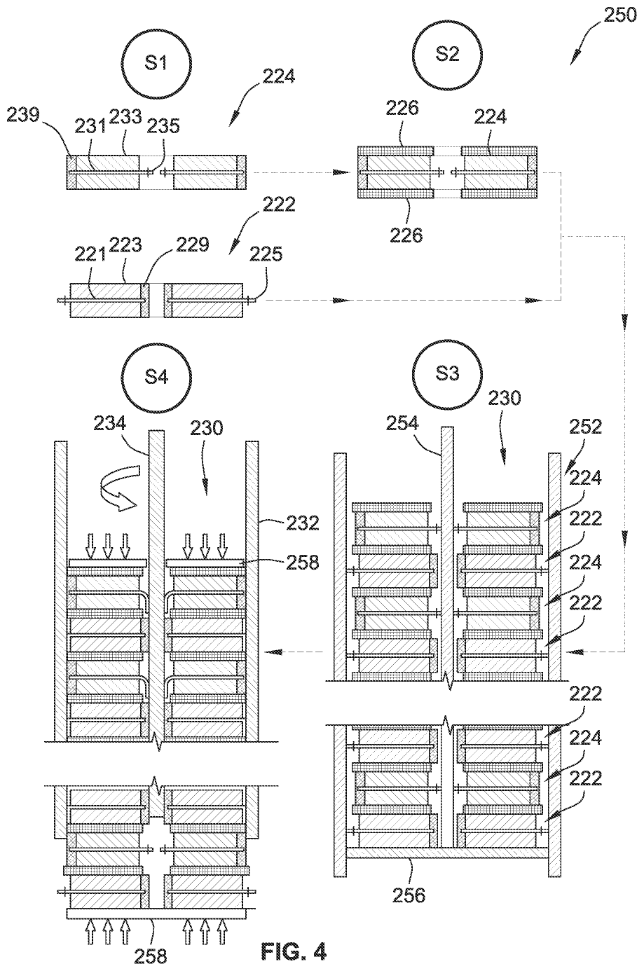

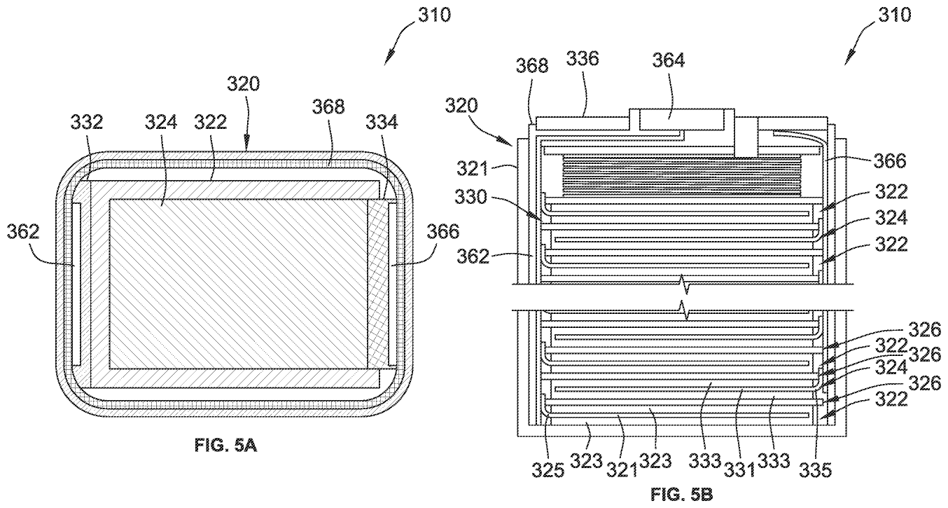

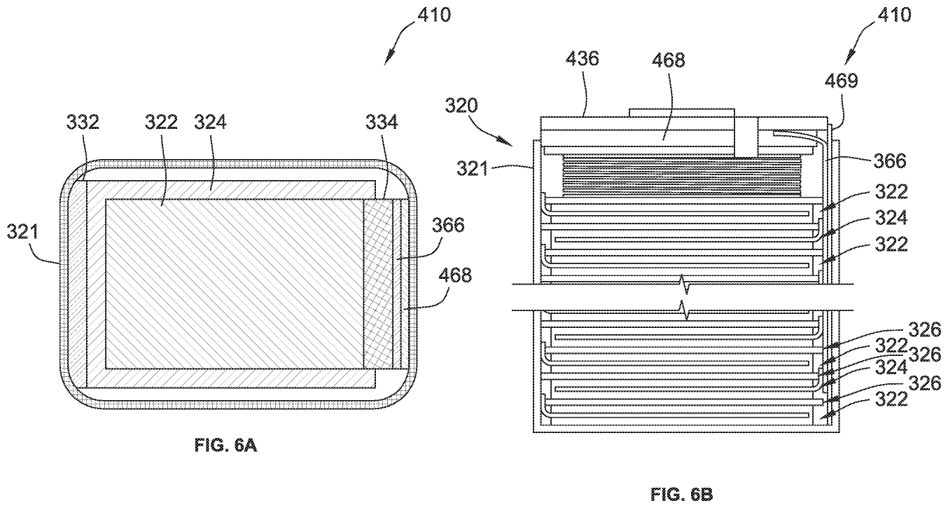

Each electrode is connected to one of the current collectors through an interference-fit mating between the current collector and the electrode's electrically conductive tabs, which are press fit onto and thereby folded against the current collector. Other weld-less interface options may include snap-fitting or key-fitting the electrodes to their designated current collectors. The cathode and anode electrode tabs may be fabricated by preforming a designated number of slits (e.g., 3-50 slits spaced around an inner edge of the electrode, or 3-100 slits spaced around an outer edge of the electrode) to enable tab folding. These slits may align with the radius of the ring-shaped electrodes or may have an angular offset from the radius. The ring-shaped electrodes may be prepared by cutting each electrode during roll-to-roll coating and processing, rotation (spin) coating, printing, scrap material recycling, etc. The stacked-electrode cylindrical cell format may be assembled using, for example, a controller-automated robotic assembly process to ensure proper stack alignment, electrode connection, and stack compression. Disclosed concepts may be applied to both cylindrical battery cells, such as those illustrated in FIGS. 3A-3C and 4, and prismatic battery cells, such as those illustrated in FIGS. 5A, 5B, 6A and 6B.

To electrically isolate the anode electrodes from the positive current collector and the cathode electrodes from the negative current collector, a layer of dielectric material or other electrically insulating material may be applied to the non-interfacing edge of each electrode (i.e., the edge that does not electrically connect to the designated current collector). Electrical isolation may also be achieved with a reduced outer diameter for the ring-shaped cathode (or anode) electrodes to prevent contact with the negative (positive) current collector, and an enlarged inner diameter for the anode (or cathode) electrodes to prevent contact with the positive (negative) current collector. While a weld-less tab-to-collector interface may be desired for ease of assembly and reduced manufacturing time and costs, mating edges of the cathode and anode electrodes may optionally be welded to their designated current collectors.

Cell assembly may include pre-laminating separator sheets onto the axial faces of the cathode electrodes, the axial faces of the anode electrodes, or select surfaces of both such that at least one separator is disposed between each neighboring pair of cathode and anode electrodes. After lamination of the separator sheets, the cathode electrodes and anode electrodes are then fed, in alternating fashion, onto a support mold that operatively aligns the electrodes to form an electrode stack. The electrode stack is then pressed into engagement with the anode and cathode current collectors via a pneumatic piston or other suitable press mechanism. Alternatively, the anode and cathode current collectors may be pressed into engagement with the electrode stack while the stack is held stationary. In either case, the electrodes are interference fit with the current collectors by press-fitting and folding the radially projecting electrode tabs onto the collectors. One or more or all of the disclosed manufacturing operations may be automated, e.g., using a robotic assembly to move and operatively position a temporary stack casing and a central collector with respect to the stacked electrodes with interleaved separators. After pressing the electrode stack into the temporary casing and onto the central collector, the stack-collector-casing subassembly is transferred for mating with a cell casing (or outer collector) and insulation layer(s). This new subassembly is then mated with a cell cap, spring plate, and spring subassembly, e.g., in a manner that ensures the stack is held in compression.

Each electrode may be stacked with an in-plane rotation of a predefined offset angle with respect to the placement of the immediately preceding electrode. For instance, a designated origin point of a first electrode may be located at 0 degree from a calibrated start coordinate. A second electrode is stacked on top of the first electrode; the designated origin point of the second electrode may be located at 1 to 60 degrees from the calibrated start coordinate. This process is repeated for each additional electrode when forming the stack. The cylindrical cell may employ a pneumatic vent or a re-sealable vent with a spring-loaded valve to allow for evacuation of gas that has been generated in the cell. The cylindrical cell may employ a spring or other suitable biasing member to provide continuous compression on the stack.

Turning next to FIGS. 3A-3C, there is shown a representative electrochemical device 210—portrayed as a rechargeable lithium-class cylindrical battery cell—with a weld-free stacked electrode architecture. The illustrated electrochemical device 210 may be implemented for vehicular applications, such as the traction battery pack 30 of electric-drive vehicle 10 of FIG. 1, as well as non-vehicular applications, such as a consumer battery, an industrial battery, a deep-cycle battery, a stand-by battery, etc. Although differing in appearance, it is envisioned that any of the features and options described below with reference to the electrochemical devices 210, 310 and 410 of FIGS. 3A, 5A and 6A, respectively, can be incorporated, singly or in any combination, into one another and the battery pack 30 of FIG. 1 or the battery 110 of FIG. 2, and vice versa. As a representative point of similarity, electrochemical device 210 (also referred to herein as “battery cell”) includes one or more first (negative or anode) working electrodes 222 and one or more second (positive or cathode) working electrodes 224, which may be packaged inside an optional cell casing (e.g., protective outer housing 120 of FIG. 2).

FIG. 3B is a plan-view illustration of one of the first (anode) electrodes 222 in the electrochemical device 210, e.g., as if taken along section line 3B-3B of FIG. 3A. For simplicity of design and ease of manufacture, it may be desirable that all of the first (anode) electrodes 222 are substantially structurally identical to one another, e.g., within acceptable manufacturing tolerances. Each anode electrode 222 may be fabricated with a substantially flat, annular main body 221, which may be stamped, cut, or machined from an electrically conductive metallic material, such as aluminum or aluminum alloy. Two layers of active (anode) electrode material 223 are secured to the opposing major faces of the electrode's main body 221. The active electrode material 223 borne by main body 221 may comprise any commercially available options including those described above with respect to the active material of anode electrode 122, for example. One or more flexible electrode tabs 225 (e.g., eight in the illustrated example) project radially outward from an outer-diameter edge of the electrode's main body 221. As shown, the electrode tabs 225 are integrally formed with the main body 221 as a single-piece structure. Covering an inner-diameter edge of the main body 221 is a coating of electrical insulation 229 that extends continuously around a central through-hole 227 of the main body 221.

For “anodeless” electrochemical device designs—with no anodes in their initial state—one or more negative electrodes function as a current collector while lithium from one or more cathode electrodes are plated on and stripped from the negative current collector(s). Put another way, lithium ions may be extracted from the cathode(s) and electrodeposited as metallic lithium onto one or more current collectors during the initial charging process. During a subsequent discharging process, lithium ions may be stripped from the current collector and intercalated back into the cathode. Eliminating lithium metal at the anode side of the as-assembled batteries or fully discharged batteries reduces concerns stemming from the presence of large amounts of lithium metal in the cell.

FIG. 3C is a plan-view illustration of one of the second (cathode) electrodes 224 in the electrochemical device 210, e.g., as if taken along section line 3C-3C of FIG. 3A. Similar to the anode electrodes 222, it may be desirable that all of the second (cathode) electrodes 224 are substantially structurally identical to one another. For instance, each cathode electrode 224 may be fabricated with a substantially flat, annular main body 231, which may be stamped, cut, or machined from an electrically conductive metallic material. A layer of active (cathode) electrode material 233 is secured to each axially spaced, opposing major face of the electrode's main body 231. The active electrode material 233 borne by the cathode's main body 231 may comprise any commercially available options including those described above with the respect to the active material of cathode electrode 122, for example. One or more flexible electrode tabs 235 (e.g., eight in the illustrated example) project radially inward from an ID edge of the electrode's main body 231. The electrode tabs 235 may extend continuously around a central through-hole 237 of the main body 231. As shown, the electrode tabs 235 are integrally formed with the main body 231 as a single-piece structure. Covering an OD edge of the main body 231 is a coating of electrical insulation 239. Alternatively, the insulation coatings 229, 239 may be altogether eliminated and the associated electrode edges thereof spaced radially inward/outward from their non-mating collectors.

A substantially flat, ring-shaped separator 226 is sandwiched between each adjacent pair of electrodes 222, 224, as best seen in the inset view of FIG. 3A. These ring-shaped separators 226 may be fabricated as porous or microporous polymeric sheets that prevent physical contact of, yet allow ionic conductivity between, their respective pairs of electrodes 222, 224. Each of the porous polymeric separator sheets 226 may be soaked with a liquid electrolyte 228 that is suitable for conducting lithium ions. For electrochemical devices employing a solid electrolyte, the separator 226 may be a non-porous structure. It is envisioned that each separator 226 is a single-piece unitary structure.

Surrounding the stack 230 of electrodes 222, 224 and interleaved separator sheets 226 is a first lithium-ion (anode) current collector 232 that helps to pass electric current between complementary working electrodes. In accord with the illustrated example, the first current collector 232 may consist essentially of a rigid metallic cylinder, e.g., that is formed of stainless steel, aluminum, nickel, or copper. With this configuration, the current collector 232 is concentrically aligned with and encases therein the first and second electrodes 222, 224. This electrically conductive cylinder may be a single-piece construction with a hollow, right-circular cylinder geometry having an open proximal end 241 that is longitudinally spaced from a closed distal end 243. The current collector 232 may function in a manner similar to the negative electrode current collector 132 described above in the discussion of FIG. 2.

In this example, the first current collector 232 may function as the device's 210 protective outer housing for isolating and safeguarding the electrode stack 230. An optional housing cap 236 may rigidly mount to and closes off the open proximal end 241 of the current collector 232. This housing cap 236 helps to secure the electrode stack 230 and other internal hardware of the electrochemical device 210 inside the current collector 232. To retain the electrode stack 230 under compression after assembly of the electrochemical device 210, a biasing member 238 applies pressure to one end of the stack 230. Although portrayed as a helical compression spring, biasing member 238 of FIG. 3A may take on any apt device that can apply compression, such as foam-type shims or cushions, leaf springs, hydraulic pressure devices, etc. For helical spring configurations, the biasing member 238 may be sandwiched between two disc-shaped polymeric spring plates: fixed spring plate 240A and movable spring plate 240B. Fixed spring plate 240A sits on an outboard side of the biasing member 238 and rigidly attaches to the collector 232, whereas the movable spring plate 240B sits on an inboard side of the biasing member 238 and slides axially within the collector 232. The biasing member 238 and plates 240A-B, in turn, are sandwiched between two disc-shaped layers of insulation 242; the stackup of spring 238, plates 240, and insulation 242 are trapped between the housing cap 236 and electrode stack 230. An active or passive vent device 245 may optionally extend through the housing cap 236 and adjoining insulation layer 242 and spring plate 240A.

Anode electrodes 222 mechanically interface with the anode current collector 232 through a folding-tab interference fit in order to electrically connect the current collector 232 to its corresponding set of electrodes 222. With reference again to FIG. 3A and the inset view presented therewith, the outer diameter D1 of the anode electrodes 222 is larger than the inner diameter D2 of the anode current collector 232. Additionally, each of the outwardly projecting electrode tabs 225 is sufficiently flexible such that pressing the electrode stack 230 into the current collector 232, or pressing the collector 232 onto the stack 230, along a central stack axis A1-A1 causes the tabs 225 to bend against circular opening at the proximal end 241 of the collector 232. Once bent, the tabs 225 slide along and press into an interior wall of the current collector 232 to thereby electrically connect the electrodes 222 to the collector 232. To obviate the chances of a short circuit, the layer of electrical insulation 239 on the outer perimeter of the second (cathode) electrodes 224 helps to electrically isolate the electrodes 224 from the current collector 232.

Packaged inside the first current collector 232 is a second lithium-ion permeable (cathode) current collector 234 that is aligned substantially parallel with the central axis A1-A1 of the electrode stack 230. In accord with the illustrated example, the second current collector 234 may consist essentially of a rigid metallic bar, e.g., that is formed of stainless steel, aluminum, nickel, or copper. This electrically conductive bar may be a single-piece construction with an elongated and solid, right-circular cylinder geometry that is secured within a central stack cavity 247 that extends through the center of the electrode stack 230. With this configuration, the current collector 234 is coaxially aligned with and seats inside the electrode stack 230. The current collector 234 may function in a manner similar to the positive electrode current collector 134 described above in the discussion of FIG. 2.

Cathode electrodes 224 mechanically interface with the cathode current collector 234 through a folding-tab interference fit in order to electrically connect the current collector 234 to its corresponding set of electrodes 224. The inner diameter D3 of the cathode electrodes 224 is smaller than the outer diameter D4 of the cathode current collector 234. Additionally, each of the inwardly projecting electrode tabs 235 is sufficiently flexible such that pressing the electrode stack 230 onto the current collector 234 and/or pressing the collector 234 into the central through-holes 237 defining the stack cavity 247 along a central stack axis A1-A1 causes the tabs 235 to bend against a proximal end of the collector 234. Once bent, the tabs 235 slide along and press against an exterior surface of the current collector 234 to thereby electrically connect the electrodes 224 to the collector 234. To obviate the chances of a short circuit, the layer of electrical insulation 229 on the inner perimeter of the first (anode) electrodes 222 helps to electrically isolate the electrodes 222 from the current collector 234.

With reference next to FIG. 4, there is shown an example of a manufacturing system and attendant manufacturing process (collectively designated as 250) for assembling an electrochemical device with a stacked electrode configuration, such as electrochemical device 210 of FIG. 3A. Some or all of the operations illustrated in FIG. 4, and described in further detail below, may be automated through execution of processor-executable instructions, for example, by manufacturing system control hardware. These instructions may be stored, for example, in main or auxiliary or remote memory, and executed, for example, by an electronic controller, processing unit, control logic circuit, or other module or device or network of modules/devices, to perform any or all of the above and below described functions associated with the disclosed concepts. It should be recognized that the order of execution of the illustrated operations may be modified, additional operations may be added, and some of the described operations may be modified, combined, or eliminated.

Manufacturing system/process 250 of FIG. 4 may begin at a first manufacturing step or station S1 by receiving a bundle of first electrodes, such as first (anode) electrodes 222, and a bundle of second electrodes, such as second (cathode) electrodes 224. Each electrode may be visually inspected and cleaned, e.g., via an operator, prior to subsequent operations. Upon receipt of one or both electrode bundles, manufacturing system/process 250 advances to a second manufacturing step or station S2 and receives a bundle of electrically insulating separators, such as ring-shaped separator sheets 226. At this juncture, each separator is sandwiched between one anode electrode and one cathode electrode. As mentioned above, this may include pre-laminating a separator sheet 226 onto each axial face of the cathode electrodes 224. As used herein, the term “receiving” may be defined to include the actual fabrication of the associated object(s) or, alternatively, may include retrieving a shipment of such object(s) or intake of such object(s) at a processing station.

Once the separators are received and operatively attached to the electrodes, manufacturing system/process 250 advances to a third manufacturing step or station S3 and stacks the electrodes with the interleaved separators. Manufacturing step/station S3 may include feeding the electrodes, one at a time and in an alternating fashion (anode, cathode, anode, cathode . . . ), onto a support mold 252 to assemble an electrode stack 230. A central locating pin 254 may be provided to axially align the electrodes and separators during stacking. The inner walls of the support mold 252 and/or the locating pin 254 may be lubricated to facilitate stacking of the electrodes. The support mold 252 may be seated on a stationary base plate 256, as shown in Step S3, or on a pneumatic, hydraulic, or motor-driven piston (“base presser”) 258, as shown in Step S4.

Manufacturing system/process 250 of FIG. 4 continues to a fourth manufacturing step or station S4 to operatively position and attach first and second current collectors, such as anode current collector 232 and cathode current collector 234, with respect to the stacked first and second electrodes. The first current collector may be pressed onto the electrode stack 230 by a technician or via a robotic arm or plunger (collectively 258). In addition, or alternatively, the electrode stack 230 may be pressed into the first current collector by a technician or the base presser 258. In so doing, the first current collector fully or partially surrounds the electrode stack 230 and the outwardly projecting electrode tabs of the first electrodes interference fit with the first current collector to thereby electrically connect the electrodes to their designated current collector. In the same vein, the second current collector may be pressed and rotated into the electrode stack 230 and/or the electrode stack 230 may be pressed onto the second current collector by a technician or the base presser 258. In so doing, the second current collector is seated inside of the first current collector and electrode stack, aligned substantially coaxial therewith, and the inwardly projecting electrode tabs of the second electrodes interference fit with the second current collector to thereby electrically connect the electrodes to their designated collector.

Turning next to FIGS. 5A and 5B, there is shown another representative electrochemical device 310—portrayed as a lithium-metal prismatic battery cell—with a stacked electrode architecture. The electrochemical device 310 employs one or more first (negative or anode) working electrodes 322 and one or more second (positive or cathode) working electrodes 324, which are packaged inside an outer housing or cell casing 320. Compared to the annular electrodes 222, 224 described above, each anode electrode 322 and cathode electrode 324 of FIG. 5B may be fabricated with a substantially flat, polygon-shaped main body 321 and 331, respectively. As a point of similarity, a layer of active electrode material 323 and 333 is secured to each opposing major face of each electrode's main body 321, 331. One or more flexible electrode tabs 325 project transversely (to the left in FIG. 5A) from one end of each of the anode electrode's main body 321. Likewise, one or more flexible electrode tabs 335 project transversely in the opposite direction of tabs 325 (to the right in FIG. 5A) from the opposite end of each of the cathode electrode's main body 331. These tabs 325, 335 may be functionally similar to the tabs 225, 235 of FIGS. 3A-3C for engaging respective current collectors.

A substantially flat, rectangular separator 326 is sandwiched between each adjacent pair of electrodes 322, 324, as best seen in FIG. 5B. The anode electrodes 322 are shown in FIG. 5A with a rectangular shape having a first (enlarged) plan-view surface area. By way of contrast, the cathode electrodes 324 have a rectangular shape with a second (reduced) plan-view surface area that is smaller than that of the anode electrodes 322. For at least some embodiments, the cathode electrodes 324 may be larger than or the same size as the anode electrodes 322. It is also within the scope of this disclosure that any of the herein described electrochemical devices, electrodes, and separators take on alternative shapes and sizes from that which are shown in the drawings. As a non-limiting example, the cell casing 320 may take on other polyhedral configurations with or without rounded corners without departing from the intended scope of this disclosure.

Seated adjacent a first face of the electrode stack 330 (left side in FIG. 5A), interposed between the stacked anode and cathode electrodes 322, 324 and a main housing body 321 of cell casing 320, is a first lithium-ion permeable (anode) current collector 332. In accord with the illustrated example, the first current collector 332 may consist essentially of a rigid metallic plate. A negative electrical connector 362 connects the anode current collector 332 to a negative terminal 364 nested on top of a housing cap 336 of the cell casing 320. Seated adjacent a second face of the electrode stack 330 (right side in FIG. 5A), interposed between the main housing body 321 and the stacked electrodes 322, 324, is a second lithium-ion permeable (cathode) current collector 334. Similar to the first current collector 332, the second current collector 334 may consist essentially of a rigid metallic plate. A positive electrical connector 366 electrically connects the anode current collector 332 to the housing cap 336, which acts as a positive terminal in this configuration. The electrode stack 330, current collectors 332, 334, and connectors 362, 366 may be encased within an insulation jacket 368 that is located inside the cell casing 320 and seats thereon the housing cap 336.

FIGS. 6A and 6B present yet another representative example of an electrochemical device 410 with a stacked electrode architecture. With the exception of those distinctions described below, the electrochemical device 410 may be similarly equipped to the electrochemical device 310 of FIGS. 5A and 5B. For instance, both devices 310, 410 are portrayed as lithium-metal prismatic battery cells with a linear stack of first electrodes 322, second electrodes 324, and separators 326. In this example, however, the anode electrodes 322 of FIG. 6A may be slightly larger and/or a main housing body 321 of the cell casing 320 may be slightly smaller than those in FIG. 5A to enable the flexible tabs of electrodes 322 to interference fit with the main body 321, which acts as the first (anode) current collector and negative terminal in this configuration. In addition, there is no insulation jacket 368; rather, a first square-shaped insulation plate 468 electrically isolates the housing cap/positive terminal 436 from the housing body/negative terminal, and a second square-shaped insulation plate 469 electrically isolates the cathode current collector 334 and positive electrical connector 366 from the housing body/anode collector 321.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. An electrochemical device, comprising:
a plurality of first electrodes each having a first active electrode material borne by a first body and a flexible first electrode tab projecting from the first body;
a plurality of second electrodes each having a second active electrode material, distinct from the first active electrode material, borne by a second body and a flexible second electrode tab projecting from the second body;
a plurality of separator layers and/or solid electrolyte layers interleaved between and stacked in an electrode stack along a central stack axis with the first and second electrodes;
a first current collector at least partially surrounding the electrode stack and interference fit with the first electrode tabs to thereby electrically connect to the first electrodes; and
a second current collector disposed inside the first current collector, aligned substantially parallel with the central stack axis, and interference fit with the second electrode tabs to thereby electrically connect to the second electrodes.

2. The electrochemical device of claim 1, wherein the first and second bodies of the first and second electrodes each has a substantially flat annular shape.

3. The electrochemical device of claim 2, wherein the first and second bodies have respective central holes coaxially aligned on the central stack axis to define a central stack cavity extending through of the electrode stack, and wherein the second current collector includes an elongated electrically conductive bar extending axially through the central stack cavity.

4. The electrochemical device of claim 3, wherein each of the second electrode tabs includes a plurality of second electrode tabs projecting radially inward from an inner-diameter (ID) edge of the second body, circumferentially spaced around the second body, and bent against an outer surface of the electrically conductive bar of the second current collector.

5. The electrochemical device of claim 4, wherein the second body of each of the second electrodes has an outer-diameter (OD) edge with a second layer of electrical insulation.

6. The electrochemical device of claim 2, wherein the first current collector includes an electrically conductive cylinder concentric with and surrounding the first and second electrodes.

7. The electrochemical device of claim 6, wherein each of the first electrode tabs includes a plurality of first electrode tabs projecting radially outward from an outer-diameter (OD) periphery of the first body, circumferentially spaced around the first body, and bent against an inner surface of the electrically conductive cylinder of the first current collector.

8. The electrochemical device of claim 7, wherein the first body of each of the first electrodes has an inner-diameter (ID) edge with a first layer of electrical insulation.

9. The electrochemical device of claim 1, further comprising a rigid outer housing containing therein the electrode stack and the first and second current collectors.

10. The electrochemical device of claim 9, wherein the outer housing includes a main housing, a housing cap closing off an open end of the main housing, and a biasing member compressed between the electrode stack and the housing cap or the main housing.

11. The electrochemical device of claim 1, wherein the first bodies of the first electrodes each has a substantially flat first polygonal shape with a first size, and the second bodies of the second electrodes each has a substantially flat second polygonal shape with a second size distinct from the first size.

12. The electrochemical device of claim 11, wherein the second current collector includes an electrically conductive plate extending longitudinally along a lateral side of the electrode stack, abutting the second electrodes, and spaced relation to the first electrodes.

13. The electrochemical device of claim 12, wherein the first current collector includes an electrically conductive hollow container coaxial with and surrounding the first and second electrodes.

14. An electrochemical device, comprising:
a plurality of first electrodes each having a first active electrode material borne by a first electrode body and a flexible first electrode tab projecting from the first electrode body;
a plurality of second electrodes each having a second electrode body and a flexible second electrode tab projecting from the second electrode body, wherein the second electrode body is configured to be plated with a second active electrode material configured to be stripped from the second electrode body;
a plurality of separator layers and/or solid electrolyte layers interleaved between and stacked in an electrode stack along a central stack axis with the first and second electrodes;
a first current collector at least partially surrounding the electrode stack and interference fit with the first electrode tabs to thereby electrically connect to the first electrodes; and
a second current collector disposed inside the first current collector, aligned substantially parallel with the central stack axis, and interference fit with the second electrode tabs to thereby electrically connect to the second electrodes.

15. A method of assembling an electrochemical device, the method comprising:
receiving a plurality of first electrodes each having a first active electrode material borne by a first body and a flexible first electrode tab projecting from the first body;
receiving a plurality of second electrodes each having a second active electrode material, distinct from the first active electrode material, borne by a second body and a flexible second electrode tab projecting from the second body;
receiving a plurality of electrically insulating separators;
interleaving each of the separators between one of the first electrodes and one of the second electrodes;
stacking the first and second electrodes with the interleaved separators along a central stack axis to define an electrode stack;
positioning a first current collector at least partially around the electrode stack such that the first electrode tabs interference fit with the first current collector to thereby electrically connect the first electrodes to the first current collector; and
positioning a second current collector inside the first current collector and aligned substantially parallel with the central stack axis such that the second electrode tabs interference fit with the second current collector to thereby electrically connect the second electrodes to the second current collector.

16. The method of claim 15, wherein the first and second bodies of the first and second electrodes each has a substantially flat annular shape.

17. The method of claim 16, wherein the first and second bodies have respective central holes coaxially aligned on the central stack axis to define a central stack cavity extending through of the electrode stack, and wherein the second current collector includes an elongated electrically conductive bar extending axially through the central stack cavity.

18. The method of claim 17, wherein each of the second electrode tabs includes a plurality of second electrode tabs projecting radially inward from an inner-diameter (ID) edge of the second body, circumferentially spaced around the second body, and bent against the outer surface of the electrically conductive bar of the second current collector.

19. The method of claim 18, wherein the first current collector includes an electrically conductive cylinder concentric with and surrounding the first and second electrodes.

20. The method of claim 19, wherein each of the first electrode tabs includes a plurality of first electrode tabs projecting radially outward from an outer-diameter (OD) periphery of the first body, circumferentially spaced around the first body, and bent against an inner surface of the electrically conductive cylinder of the first current collectors.
